(19) United States
(12) Patent Application Publication
(10) Pub. No.: US 2025/0289010 A1
(43) Pub. Date: Sep. 18, 2025

(54) ABLUTIONARY NOZZLE ASSEMBLY

(71) Applicant: Kohler Mira Limited, Cheltenham (GB)

(72) Inventors: Daniel Blenkarn, Cheltenham Gloucestershire (GB); Oliver Jones, Cheltenham (GB)

(21) Appl. No.: 19/075,172

(22) Filed: Mar. 10, 2025

(30) Foreign Application Priority Data
Mar. 12, 2024 (GB) 2403566.9
Feb. 14, 2025 (EP) 25157954.6

(51) Int. Cl. B05B 5/035; E03C 1/04

(52) U.S. Cl. CPC B05B 5/035; E03C 1/0408

(57) ABSTRACT

An ablutionary nozzle assembly is provided for use in an ablutionary fitting. The ablutionary nozzle includes one or more nozzles and one or more pairs of electrodes. The nozzles and pairs of electrodes are arranged such that, in use, an electric potential difference applied across the one or more pairs of electrodes controls the deflection of water jets passing through each of the one or more nozzles.

### CROSS REFERENCE

This application claims priority to EP Application Serial No. 25157954.6, filed 14 Feb. 2025, which itself claims priority to GB Patent Application No. 2403566.9, filed 12 Mar. 2024, the entireties of both of which are hereby incorporated by reference.

### FIELD OF THE INVENTION

The present invention relates to an ablutionary nozzle assembly for use in ablutionary fitting such as a shower system, a tap, a faucet or the like or any combination of such devices. More specifically, the present invention relates to an ablutionary nozzle assembly able to deflect a jet of water. The present invention also relates to ablutionary fittings comprising the ablutionary nozzle assembly and methods performed by the ablutionary nozzle assembly.

### BACKGROUND OF THE INVENTION

In order to provide an improved user experience it is desirable to provide an ablutionary fitting which allows the deflection of water jets produced to be varied, either per use or over time within the duration of a shower experience. The controllable deflection of the water jets may allow variations between users to be accommodated or provide for different shower experiences such as invigorating sports warm down showers or gentle morning waking-up showers.

### BRIEF DESCRIPTION OF THE DRAWINGS

Embodiments of the invention will now be described, by way of example only, with reference to the accompanying drawings, in which:

FIG. 1 illustrates (A) a schematic cross section view of an example ablutionary nozzle assembly, (B) a schematic overhead view of an example ablutionary nozzle assembly, and (C) a schematic cross section view of an example ablutionary nozzle assembly in use.

FIG. 2 shows (A) a schematic overhead view of an example ablutionary nozzle assembly, (B) a schematic overhead view of an example ablutionary nozzle assembly and (C) a schematic overhead view of an example ablutionary nozzle assembly.

FIG. 3 shows a schematic cross section of an example ablutionary fitting comprising four example ablutionary nozzle assemblies.

FIG. 4 shows an example method of directing water flow through an example ablutionary nozzle assembly.

FIG. 5 shows an example method of adjusting the direction of water flow through an example ablutionary nozzle assembly.

FIG. 6 shows an example method of adjusting the spray pattern of water exiting an example ablutionary fitting.

### DETAILED DESCRIPTION OF THE DRAWINGS

An example ablutionary nozzle assembly is provided for use in an ablutionary fitting. The nozzle assembly includes one or more nozzles and one or more pairs of electrodes. The nozzles and pairs of electrodes are arranged such that, in use, an electric potential difference applied across the one or more pairs of electrodes controls the deflection of water jets passing through each of the one or more nozzles.

Due to the unequal distribution of charge across a water molecule, a stream or jet of water passing through an electric field is deflected. A water jet is deflected towards the positive terminal or anode. This allows for control to deflect water jets in an ablutionary setting.

The deflection of water may be controlled electrostatically by the electric potential difference applied across a pair of electrodes requires no moving parts. The maintenance costs and potential for failure of the assembly is therefore reduced compared to an assembly where the deflection of the water jet is controlled by moving parts.

The axis (a) extending between the electrodes of a pair of electrodes may be perpendicular to the axis (b) extending in the direction of water flow through the one or more nozzles and located an equal distance from each of the apertures of each of the one or more nozzles.

This orientation of electrodes with respect to the one or more nozzles provides the greatest degree of deflection per electrode pair. The one or more nozzles may be oriented such that the direction of water flow through the nozzles is substantially the same for all the nozzles in the assembly. Where the ablutionary nozzle assembly includes just one nozzle, axis (b) may be located in and passes through the centre of the aperture of this nozzle.

The ablutionary nozzle assembly may include a single pair of electrodes. Alternatively, the ablutionary nozzle assembly may comprise two or more pairs of electrodes, for example three or more pairs of electrodes, four or more pairs of electrodes or five or more pairs of electrodes. Additional pairs of electrodes provide additional vectors, referred to herein as deflection vectors, along which the water jet may be deflected. The ablutionary nozzle assembly may include from two to ten pairs of electrodes, for example from two to eight pairs of electrodes, from two to six pairs of electrodes, from two to four pairs of electrodes or from four to eight pairs of electrodes. The additional deflection vectors contributed by each additional pair of electrodes may be reduced for each additional pair of electrodes.

The axis (a) extending between the electrodes of a pair of electrodes may be rotationally offset by from 5 to 90 degrees around the axis (b) extending in the direction of water flow through the one or more nozzles and located an equal distance from each of the apertures of each of the one or more nozzles from the axes (a) extending between the electrodes of other pair of electrodes in the nozzle assembly. A degree of separation between the axes (a) of the electrode pairs can improve the efficiency and degrees of accuracy of the assembly when deflecting the water jet.

The nozzle may be positioned such that the axis (b) extending in the direction of water flow through the one or more nozzles and located an equal distance from each of the apertures of each of the one or more nozzles intersects with the axis (a) extending between the electrodes of each pair of electrodes. This positioning, in which the water jet produced by the nozzle passes between the electrodes of each pair of electrodes, can improve the efficiency of the assembly when deflecting the water jet.

The aperture of each of the one or more nozzles may have a diameter of from 0.1 mm to 30 mm, such as from 0.2 mm to 20 mm, or 0.3 mm to 10 mm. Nozzle apertures having these dimensions may be suitable for ablutionary applications, allowing sufficient water to pass through the aperture at sufficient pressure for washing and personal hygiene.

The electrodes may be positioned at the outlet of the one or more nozzles or downstream of the one or more nozzles such that the water jet exiting each nozzle passes between the two electrodes of each pair. Positioning the electrode pairs in this position can improve the efficiency of the assembly when deflecting the water jet. The electrodes and nozzle may be mounted on a support, optionally in the above configuration. The support may be, for example, the casing of an ablutionary fitting.

An example ablutionary nozzle assembly may include a single nozzle. A single nozzle in the assembly can allow more control over an individual jet and therefore collections of such assemblies, for example in an ablutionary fitting, can create more intricate patterns than when multiple nozzles are present in the assemblies. Alternatively, the ablutionary nozzle assembly may include two or more nozzles, such as three or more, or four or more. The nozzle assembly may comprise from two to eight nozzles, such as from two to seven nozzles, from two to four nozzles, or from three to six nozzles. Axis (b), extending in the direction of water flow through the one or more nozzles, is located an equal distance from each of the apertures of each of the one or more nozzles. Two or more nozzle in the assemblies may be more efficient as several water jets can be controlled by a single assembly.

The electrodes may be physically separated from the one or more water jets formed when the ablutionary nozzle assembly is in use. Preventing contact between the water jet and the electrodes can prevent corrosion of the electrodes, extend the lifespan of the nozzle assembly, reduce maintenance costs and the potential for failure of the assembly. Physical separation may be achieved by placing the electrodes such that the support on which they are mounted, such as the casing of an ablutionary fitting, is between the electrode and the water jet when the ablutionary nozzle assembly is in use.

An example ablutionary fitting may include one or more ablutionary nozzle assemblies.

The ablutionary fitting may be a shower head, a tap or a faucet. The ablutionary fitting may be suitable for applications that involve directing water towards a user.

An example ablutionary fitting may include two or more ablutionary nozzle assemblies, such as three or more, four or more, five or more, ten or more, twenty or more or one hundred or more. Combining two or more assemblies may allow the ablutionary fitting to provide complex spray patterns that vary with time, with user or with both.

By spray pattern means the spatial geometry of water spray created by the dispersion device. The dispersion device may be an example ablutionary nozzle assembly or an example ablutionary fitting of the present invention. The pattern of the water spray may, for example, be varied between a narrow-focused jet and a wide diverging water spray.

The electrode pairs may be in electrical communication with a controller. The controller may be configured to alter the electric potential difference applied across each pair of electrodes in accordance with a programmed pattern stored locally or remotely. This may allow a user to select preloaded spray patterns or upload spray patterns that would run whilst using the ablutionary fitting.

A example method of directing water flow through an ablutionary nozzle assembly is provided. A first step may include applying a first electrostatic difference across a first pair of electrodes to deflect the one or more water jets by a first deflection amount. A second step may include applying a second electrostatic difference across the first pair of electrodes to deflect the one or more water jets by a second deflection amount.

This method can create spray patterns using the ablutionary nozzle assembly to enhance the user experience.

The ablutionary nozzle assembly may include two or more pairs of electrodes. In the first step, a third electric potential difference across a second pair of electrodes may be applied such that the combination of the first and second electric potential differences deflect the one or more water jets by a first deflection amount, and in the second step a fourth electric potential difference may be applied across the second pair of electrodes such that the combination of the first and second electric potential differences deflect the one or more water jets by a second deflection amount. That additional pairs of electrodes in the nozzle assembly may allow a greater accuracy of deflection for the one or more water jets, and the method can therefore create more intricate spray patterns to further enhance the user experience.

In a third step, additional electric potential differences may be applied across the first pair of electrodes and the second pair of electrodes if present, to deflect the one or more water jets by a third deflection amount. Additional steps may allow more intricate spray patterns to be created, further enhancing the user experience.

An example method may be provided for directing water flow through an ablutionary fitting. The ablutionary fitting may have one or more ablutionary nozzle assemblies. The method may be applied to each of the one or more nozzle assemblies in order to create a spray pattern that changes during use of the ablutionary fitting.

The first and second, and third if present, deflection amounts may be individually the same for each of the one or more nozzle assemblies, or different for each of the nozzle assemblies, such that various spray patterns can be created. Spray pattern may therefore be varied over time to create different user experiences.

An example method may be provided for adjusting the direction of water flow through the ablutionary nozzle assembly. The electric potential difference across the one or more electrode pairs may be determined in response to a user input before or during use of the ablutionary nozzle assembly.

The user may provide an input that determines the electric potential difference across the one or more electrode pairs of the ablutionary nozzle assembly, before or during use. By way of example, the input could be the user's height. The deflection of the water may be adjusted through changing the electric potential difference across one or more electrode pair to accommodate the user's height. Other inputs could be relevant to the deflection of the water jet from the nozzle.

An example method may be provided for varying the spray pattern of water exiting an ablutionary fitting having one or more ablutionary nozzle assemblies. The electric potential difference across the ablutionary nozzle assembly may be varied such that the spray pattern is varied.

Examples of spray patterns include a jet or a spray. The jet may be a narrow-focused jet. The spray may be a wide, diverging water spray. Examples of sprays include a full body spray comprising several individual streams directed over a wide area such as a user's back, power sprays comprising several individual streams focused on a narrow area, mists wherein the water flowing through the assembly is formed into fine droplets and fragmented mists comprising several individual streams of fine droplets.

The spray pattern may be varied between a jet and a spray, such as a narrow-focused jet and a wide diverging spray.

The ablutionary nozzle assembly may include two or more nozzles and two or more pairs of electrodes. The water flowing through each nozzle may be directed by the electric potential difference across the pairs of electrodes such that the streams cross, forcing a spray to form by the interaction of streams at high pressure. The electric potential difference across the pairs of electrodes may be changed such that the water flowing through each of the nozzles travels in the same direction without interaction, or focus towards a point, thereby forming a jet. The electric potential differences across the one or more pairs of electrodes at any single moment may be referred to as an electric potential difference pattern. This electric potential difference pattern will correspond to a spray pattern of water exiting the ablutionary fitting.

An example method may include applying a first pattern of electrostatic difference across the one or more electrode pairs of the one or more ablutionary nozzle assembly to produce a first spray pattern. The method may further include applying a second pattern of electrostatic difference across the one or more electrode pairs of the one or more ablutionary nozzle assembly to produce a second spray pattern.

In some examples, an example ablutionary fitting may include two or more ablutionary nozzle assemblies, such as three or more, four or more, five or more, ten or more, twenty or more or one hundred or more ablutionary nozzle assemblies. For example, the electric potential difference across the nozzles of the assemblies may direct the water flowing through the nozzles to interact such that they form a mist, or focus the water on a point, forming a jet.

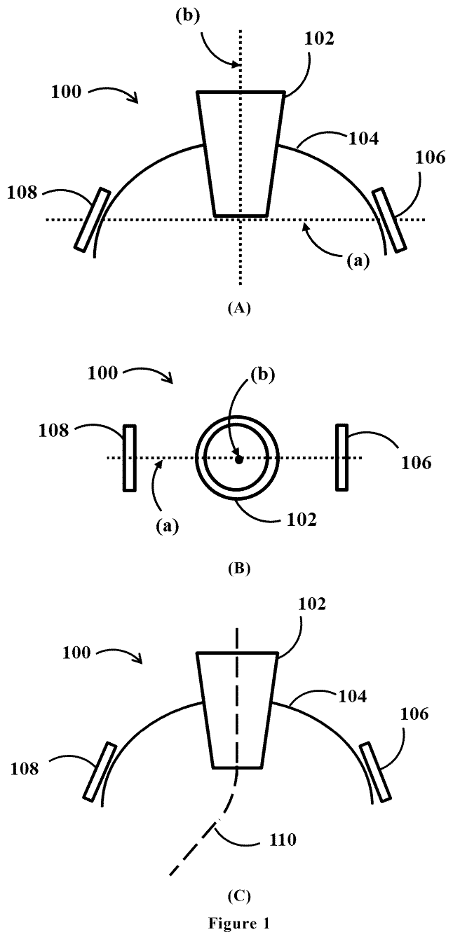

A cross section of an ablutionary nozzle assembly 100 is shown schematically in FIG. 1(A). The ablutionary nozzle assembly 100 comprises a nozzle 102 defining axis (b) extending in the direction of water flow through the nozzle and located in the centre of the aperture of this nozzle. The nozzle 102 is positioned on support 104, which may form part of an ablutionary fitting such as a shower system, shower head, a tap, a faucet or the like. The assembly further comprises a pair of electrodes 106, 108 defining axis (a) extending between the two electrodes of the pair of electrodes. The electrodes are positioned on a support 104 and are physically separated by the support 104 from the water jet produced by the nozzle 102 when in use.

An overhead view of the ablutionary nozzle assembly 100 along the nozzle 102 is shown schematically in FIG. 1(B). Axis (b) is shown passing through the nozzle aperture, arranged perpendicular to axis (a) extending between the two electrodes of the pair of electrodes 106, 108.

A cross section of the ablutionary nozzle assembly 100 in use is shown schematically in FIG. 1(C). The water jet 110 is deflected towards the anode.

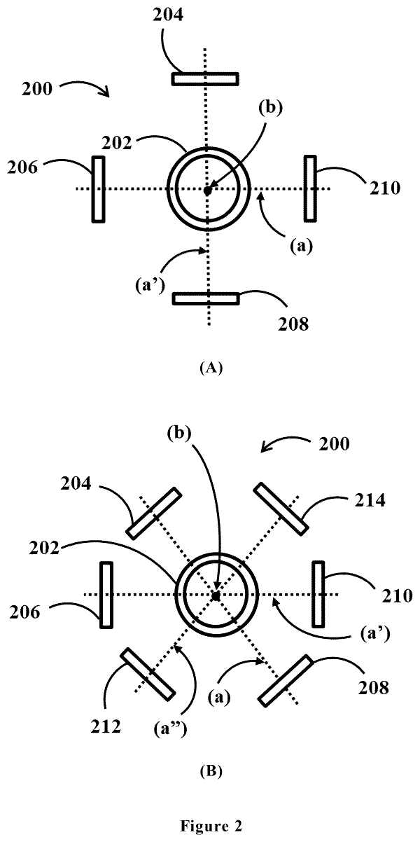

A cross section of an ablutionary nozzle assembly 200 comprising two pairs of electrodes is shown schematically in FIG. 2(A). The ablutionary nozzle assembly 200 comprises a nozzle 202 defining axis (b) extending in the direction of water flow through the nozzle and located in the centre of the aperture of this nozzle. The assembly further comprises a first pair of electrodes 204, 208 defining axis (a) extending between the two electrodes 204, 208 of the pair of electrodes, and a second pair of electrodes 206, 210 defining axis (a′) extending between the two electrodes 206, 210 of the pair of electrodes. Both axes (a) and (a′) are perpendicular to axis (b). Both axes (a) and (a′) are oriented 90° from one another around axis (b).

A cross section of an ablutionary nozzle assembly 200 comprising three pairs of electrodes is shown schematically in FIG. 2(B). The ablutionary nozzle assembly 200 comprises a nozzle 202 defining axis (b) extending in the direction of water flow through the nozzle and located in the centre of the aperture of this nozzle. The assembly further comprises a first pair of electrodes 204, 208 defining axis (a) extending between the two electrodes 204, 208 of the pair of electrodes, and a second pair of electrodes 206, 210 defining axis (a′) extending between the two electrodes 206, 210 of the pair of electrodes. The assembly further comprises a third pair of electrodes 212, 214 defining axis (a″) extending between the two electrodes 212, 214 of the pair of electrodes. Axes (a), (a′) and (a″) are perpendicular to axis (b). Axes (a), (a′) and (a″) are oriented 60° from one another around axis (b).

A cross section of an ablutionary nozzle assembly 200 comprising two pairs of electrodes and four nozzles is shown schematically in FIG. 2(C). The ablutionary nozzle assembly 200 comprises four nozzles 202, 212, 214, 218 oriented such that the direction of water flow through the nozzles is substantially the same for all the nozzles. Axis (b) extends in the direction of water flow through the four nozzles and is located an equal distance from each of the apertures of each of the four nozzles. The assembly further comprises a first pair of electrodes 204, 208 defining axis (a) extending between the two electrodes 204, 208 of the pair of electrodes, and a second pair of electrodes 206, 210 defining axis (a′) extending between the two electrodes 206, 210 of the pair of electrodes. Both axes (a) and (a′) are perpendicular to axis (b). Both axes (a) and (a′) are oriented 90° from one another around axis (b).

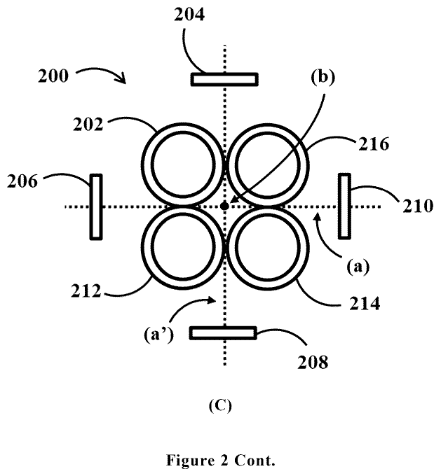

A cross section of an ablutionary fitting 300 comprising four ablutionary nozzle assemblies 302, 304, 306, 308 is shown in FIG. 3. Each ablutionary nozzle assembly comprises a nozzle 310 and a pair of electrodes 312, 314. The nozzle and pair of electrodes are positioned on a support which is part of the casing 316 of the ablutionary fitting. The ablutionary fitting further comprises a conduit 318 fluidly coupled to the ablutionary nozzle assemblies 302, 304, 306, 308 to transfer water from the water supply, such as the water mains. The ablutionary fitting may further comprise an electrical supply (not shown), such as a battery or electrical mains connection, to provide power to the electrode pairs of the ablutionary nozzle assemblies 302, 304, 306, 308.

In the example of FIG. 3, the ablutionary fitting 300 comprises four ablutionary nozzle assemblies 302, 304, 306, 308 fluidly coupled to the conduit 318. In other embodiments, the ablutionary fitting may comprise one or more ablutionary nozzle assemblies, each fluidly coupled to the conduit. In some embodiments, each assembly may have an individually controllable water supply (e.g. supplied by a plurality of separate conduits).

The ablutionary fitting 300 further comprises a coupling mechanism 320 arranged to removably couple the ablutionary fitting to a water outlet. The coupling mechanism may be formed by a two-part bayonet fit coupling, or a screw fit coupling, snap fit coupling, push fit coupling, friction fit coupling or any other suitable coupling mechanism.

The coupling mechanism may be manually operated by the user. This may allow the user to replace the ablutionary fitting with an alternative ablutionary fitting or remove and replace it for cleaning without the use of tools.

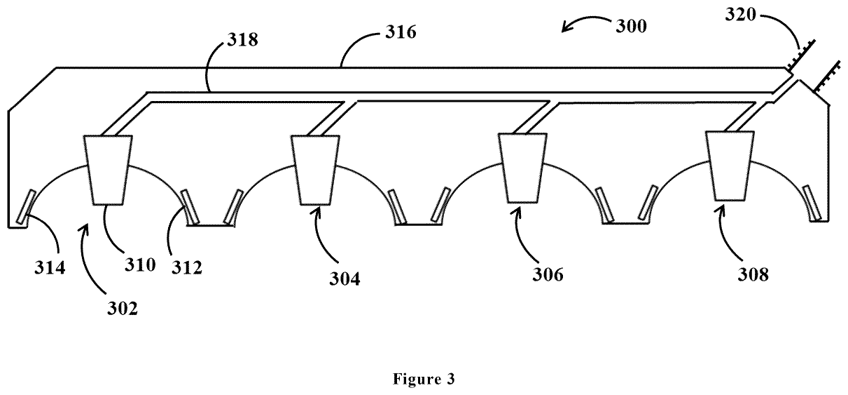

A method of directing water flow through an ablutionary nozzle assembly of the invention is shown in FIG. 4. The method comprises a first step of applying a first electrostatic difference across a first pair of electrodes 400. This results in the deflection of a water jet passing through the nozzle assembly by a first deflection amount 402. The method comprises a further step of applying a second electrostatic difference across the first pair of electrodes 404 to deflect the water jet by a second deflection amount 406. The method comprises a further step of applying a third electrostatic difference across the first pair of electrodes 408 to deflect the water jet by a third deflection amount 410.

The terms degree of deflection and deflection amount are used interchangeably herein and refer to the distance the water jet is deflected by the electric potential difference applied across electrode pair or pairs in degrees from the path that the water jet would take if no electric potential difference was applied across the electrode pair or pairs.

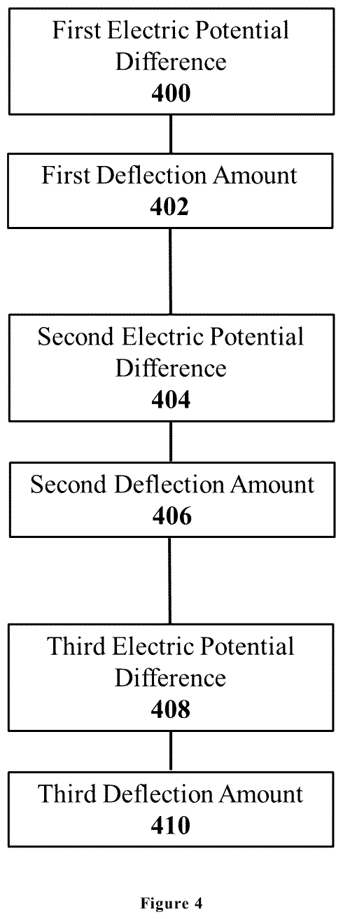

A method of adjusting the direction of water flow through the ablutionary nozzle assembly of the invention is shown in FIG. 5. The method comprises adjusting the electric potential difference across the one or more electrode pairs 502 in response to a user input 500 provided before or during use of the ablutionary nozzle assembly.

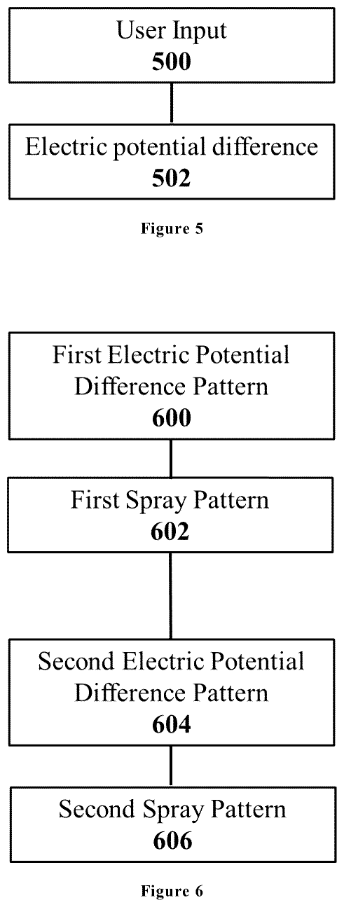

A method of varying the spray pattern of water exiting an ablutionary fitting comprising one or more ablutionary nozzle assembly of the invention through varying the electric potential difference across the one or more ablutionary nozzle assemblies is shown in FIG. 6. The method comprises applying a first pattern of electrostatic difference 600 across the one or more electrode pairs of the one or more ablutionary nozzle assembly to produce a first spray pattern 602. The method comprises a further step of applying a second pattern of electrostatic difference 604 across the one or more electrode pairs of the one or more ablutionary nozzle assembly to produce a second spray pattern 606.

1. An ablutionary nozzle assembly for use in an ablutionary fitting, the nozzle assembly comprising:
one or more nozzles; and
one or more pairs of electrodes,
wherein the nozzles and pairs of electrodes are arranged such that, in use, an electric potential difference applied across the one or more pairs of electrodes controls the deflection of water jets passing through each of the one or more nozzles.

2. The ablutionary nozzle assembly of claim 1, wherein an axis (a) extending between the electrodes of a pair of electrodes is perpendicular to an axis (b) extending in the direction of water flow through the one or more nozzles and located an equal distance from each aperture of the one or more nozzles.

3. The ablutionary nozzle assembly of claim 2, wherein the assembly comprises two or more pairs of electrodes.

4. The ablutionary nozzle assembly of claim 2, wherein:
a) the one or more axis (a) extending between the electrodes of a pair of electrodes intersects with axis (b) such that axis (b) passes between the electrode pairs; and/or
b) the aperture of each of the one or more nozzles has a diameter of from 0.1 mm to 30 mm.

5. The ablutionary nozzle assembly claim 1, wherein:
a) the electrodes are positioned downstream of the one or more nozzles such that the one or more water jets pass between the two electrodes of each pair of electrodes after exiting the nozzle; and/or
b) the electrodes are physically separated from the one or more water jets formed when the ablutionary nozzle assembly is in use.

6. The ablutionary nozzle assembly of claim 1, wherein:
a) the assembly comprises a single nozzle, or
b) the assembly comprises from two to four nozzles.

7. An ablutionary fitting comprising:
an ablutionary nozzle assembly including:
one or more nozzles; and
one or more pairs of electrodes,
wherein the nozzles and pairs of electrodes are arranged such that, in use, an electric potential difference applied across the one or more pairs of electrodes controls the deflection of water jets passing through each of the one or more nozzles.

8. The ablutionary fitting of claim 7, wherein:
a) the ablutionary fitting further comprises two or more ablutionary nozzle assemblies, and/or
b) the electrode pairs are in electrical communication with a controller, said controller altering the electric potential difference applied across each pair of electrodes in accordance with a programmed pattern.

9. A method of directing water flow through an ablutionary nozzle assembly, the method comprising the steps of:
providing an ablutionary nozzle assembly including:
one or more nozzles, and
one or more pairs of electrodes,
wherein the nozzles and pairs of electrodes are arranged such that, in use, an electric potential difference applied across the one or more pairs of electrodes controls the deflection of water jets passing through each of the one or more nozzles;
applying a first electric potential difference across a first pair of electrodes to deflect the water jet by a first deflection amount; and
applying a second electric potential difference across the first pair of electrodes to deflect the water jet by a second deflection amount.

10. The method of claim 9, wherein the ablutionary nozzle assembly comprises two or more pairs of electrodes, and wherein the method further comprises:
applying a third electric potential difference across a second pair of electrodes such that the combination of the first and second electric potential differences deflect the water jet by a first deflection amount, and
applying a fourth electric potential difference across the second pair of electrodes such that the combination of the first and second electric potential differences deflect the water jet by a second deflection amount.

11. The method of claim 9, further comprising:
applying additional electric potential differences across the first pair of electrodes and the second pair of electrodes when present to deflect the water jet by a third deflection amount.

12. A method of adjusting a direction of water flow through the ablutionary nozzle assembly of claim 1, wherein the electric potential difference across the one or more electrode pairs is determined in response to a user input before or during use of the ablutionary nozzle assembly.

13. A method of varying the spray pattern of water exiting an ablutionary fitting comprising one or more ablutionary nozzle assembly of claim 1, wherein the electric potential difference across the one or more ablutionary nozzle assemblies is varied such that the spray pattern is varied.

14. The method of claim 13, wherein the spray pattern is varied between a jet and a spray.

15. The ablutionary nozzle assembly of claim 3, wherein axis (a) for each pair of electrodes is rotationally offset by from 5 to 90 degrees around axis (b) from the axis (a) for every other pair of electrodes in the nozzle assembly.
